(19) United States
(12) Patent Application Publication
(10) Pub. No.: US 2011/0305975 A1
(43) Pub. Date: Dec. 15, 2011

(54) CATALYTIC PARTICULATE SOLUTION FOR A MICRO FUEL CELL AND RELATED METHOD

(75) Inventors: Antoine Latour, Grenoble (FR); Sylvain Nizou, Noizay (FR)

(73) Assignees: Commissariat A L'Engergie Atomique et Aux Energies Alternatives, Paris (FR); STMICROELECTRONICS (TOURS) SAS, Tours (FR)

(21) Appl. No.: 13/139,573

(22) PCT Filed: Dec. 15, 2009
(86) PCT No.: PCT/EP09/67217

§ 371 Date: Aug. 30, 2011

(30) Foreign Application Priority Data
Dec. 16, 2008 (FR) 08/58629

(51) Int. Cl. H01M 4/92; C08F 2/50; H01M 4/88; B01J 31/08; B82Y 40/00; B82Y 30/00

(52) U.S. Cl. 429/524; 429/525; 429/526; 429/527; 502/159; 427/508; 977/892; 977/948; 977/742

(57) ABSTRACT

A catalytic particulate solution is provided for a micro fuel cell. The solution includes a suspension of catalytic nanoparticles in a solvent and a polymerizable oligomer. Also presented is a method for depositing such a catalytic particulate solution that includes a step of depositing the particulate solution onto a substrate, during which the oligomer polymerization is primed, for example, using UV lighting.

### PRIORITY CLAIM

This application is a 371 filing from PCT/EP2009/067217 filed Dec. 15, 2008, which claims priority from French Application for Patent No. 08/58629 filed Dec. 16, 2008, the disclosures of which are hereby incorporated by reference.

### TECHNICAL FIELD

The present invention relates to a catalytic particulate solution comprising a suspension of catalytic nanoparticles in a solvent and a polymerizable oligomer, and also to a process of depositing such a catalytic particulate solution, for example for the manufacture of micro fuel cells.

The invention relates in particular to the field of fuel cells, and more particularly fuel cells having a solid polymer membrane as electrolyte, such as PEMFCs (Proton Exchange Membrane Fuel Cells) and DMFCs (Direct Methanol Fuel Cells).

### BACKGROUND

Generally, fuel cells consist of a stack of individual cells.

Each of these individual cells comprises an anode and a cathode placed on either side of an electrolyte. The fuel, such as hydrogen H₂ for hydrogen fuel cells, is oxidized at the anode, thus producing protons and electrons. The electrons rejoin the external electric circuit, whereas the protons are sent toward the cathode, through the electrolyte, which is generally in the form of an ion-conducting membrane. Reduction of the oxidizing agent, such as oxygen from the air, takes place at the cathode, accompanied, in the case of hydrogen fuel cells, by the production of water resulting from the recombination of the ions produced by the reduction and of the protons.

The production of low-power fuel cells, i.e. with a power of 0.5 to 50 W per cell, known as micro fuel cells, requires the development of architectures and processes which are often derived from technologies used in microelectronics.

One difficulty lies in assembling the micro-electrode with the thin film of proton-conducting material.

Furthermore, the micro-electrode must have a high electronic conductivity, a high permeability to gas, in particular to hydrogen, in the case of a PEMFC architecture for hydrogen/air fuel cells, a high permeability to gas and to methanol in the case of a DMFC architecture for methanol/air fuel cells, an ability to take the form of a thin film on a small surface area, and a good thermomechanical strength.

The micro-electrode must also have a surface which is suitable for the deposition of a catalyst in dispersed form.

Conventionally, the process for manufacturing a micro fuel cell comprises the following successive steps:

etching an array of holes on a substrate that is porous to gas, in particular to hydrogen;

depositing an anode comprising, for example, a current collector and a layer of catalyst deposited by spraying a catalytic particulate solution, in particular by droplet spraying;

converting the solution via evaporation of the solvent from said catalytic particulate solution;

depositing a thin electrolyte membrane, in particular in the form of a thin film of NAFION®, for example deposited by dip-coating; and

depositing a layer of catalyst on the electrolyte membrane in order to activate the reaction at the cathode, followed by a metallic deposition, intended to ensure the collection of the electric current at the cathode.

The catalyst is conventionally deposited on the anode by methods for depositing a catalytic particulate solution, also known as catalytic ink, comprising a suspension of catalytic nanoparticles in an aqueous or organic solvent.

However, during the conversion step, some of the catalytic particulate solution flows into the holes of the porous substrate. Such flows are prejudicial in terms of performance for the micro fuel cell. Indeed, the holes of the array are used to circulate the fuel, such as hydrogen H₂ in the case of hydrogen fuel cells. A flow of the particulate solution into the holes of the array renders the volume of catalytic solution in the holes inactive for the catalysis.

### SUMMARY

An embodiment proposes a catalytic particulate solution for a micro fuel cell which, once deposited on the electrodes, in particular would no longer flow into the holes of the array.

A catalytic particulate solution is proposed for a micro fuel cell comprising a suspension of catalytic nanoparticles in a solvent and a polymerizable oligomer.

Advantageously, the oligomer will polymerize during the deposition of the particulate solution on the electrode so as to sufficiently increase the viscosity of the particulate solution in order to prevent the particulate solution from flowing into the holes of the array. The use of a particulate solution during the implementation of a process for manufacturing a micro fuel cell makes it possible to prevent the solution from flowing into the holes of the array and to keep the solution at the surface of the structure in contact with the electrodes.

A catalytic particulate solution may also comprise one or more of the optional features below, considered individually or according to all the possible combinations:

the oligomer is polymerizable according to a chain reaction;

the oligomer is selectively activatable, for example photoactivatable;

the particulate solution comprises an initiator for the polymerization reaction of the oligomer;

the particulate solution comprises a proton-conducting polymer, for example Nafion®;

the catalytic nanoparticles are in the form of carbon nanoparticles, for example carbon nanotubes, bonded to a catalyst;

the catalytic nanoparticles comprise at least one metal catalyst, for example an element from groups 6 to 11;

the particulate solution comprises a catalyst for the polymerization reaction of the oligomer;

the solvent is aqueous;

the proton-conducting polymer and the oligomer are chosen so as not to react together during the polymerization reaction.

Another embodiment is a process for depositing the catalytic particulate solution, comprising a step of depositing, in particular by spraying, the particulate solution onto a substrate, during which the polymerization of the oligomer is initiated, for example by means of UV light.

The process may also comprise one or more of the optional features below, considered individually or according to all the possible combinations:
before the deposition step, a photosensitive initiator for the polymerization reaction of the oligomer is added to the catalytic particulate solution;
before the deposition step, the substrate is heated to a temperature between 30° C. and 100° C.

An embodiment further comprises a fuel cell, characterized in that the catalytic layer placed in contact with the electrodes originates from a catalytic particulate solution as described above.

Another embodiment is an electronic component comprising a power source, characterized in that the power source is a fuel cell as described above.

### BRIEF DESCRIPTION OF THE DRAWINGS

The invention will be better understood on reading the description which follows, given solely by way of example and with reference to the appended drawings in which:

FIG. 1 is a schematic cross-sectional view of a micro fuel cell according to the invention; and

FIG. 2 is a schematic representation of a step of the process for depositing a particulate solution according to the invention.

### DETAILED DESCRIPTION OF THE DRAWINGS

For reasons of clarity, the various elements represented on the figures are not necessarily to scale. In particular, the thickness of the layers and the sizes of the holes of the array are not to scale.

As used herein, the term “oligomer” is understood to mean a molecule that consists of a finite number n of monomers, for example n is less than or equal to 10.

As used herein, the expression “conversion of the solution” is understood to mean any physical and/or physicochemical and/or chemical conversion which gives rise to an increase in the viscosity of the solution, for example the evaporation of the solvent or the polymerization of a monomer contained in the solution.

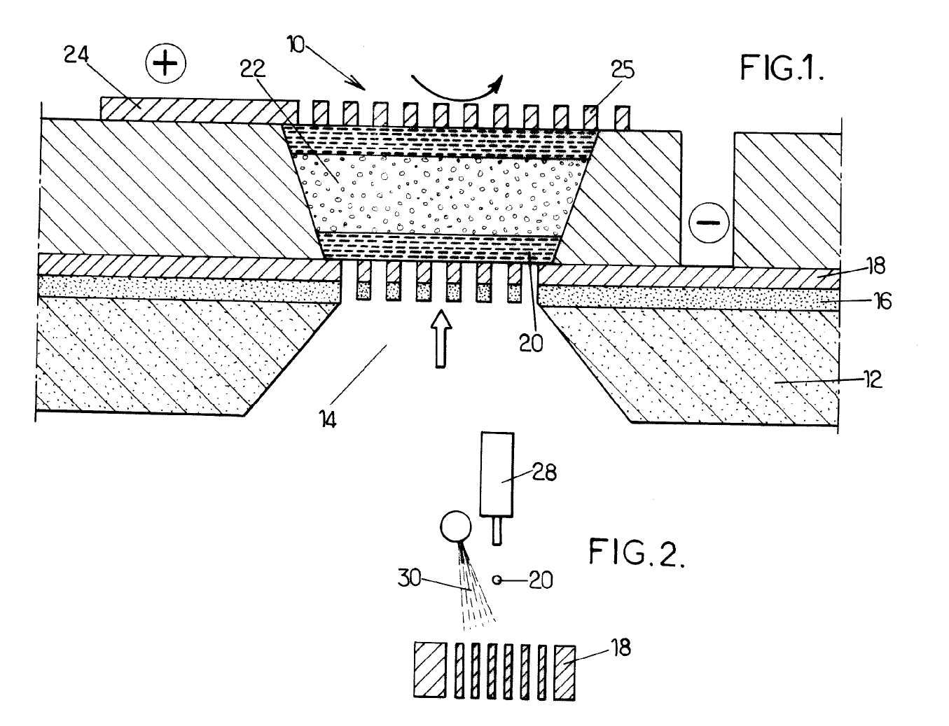

FIG. 1 is a schematic cross-sectional view of an example of a micro fuel cell. The micro fuel cell 10 represented in FIG. 1 comprises a substrate 12, for example made of single-crystal silicon. An opening 14 is made in the substrate 12 in order to allow the passage of gaseous fuel such as hydrogen in the case of micro hydrogen fuel cells. The substrate 12 is covered with a layer of dielectric 16, for example silicon dioxide SiO₂.

The dielectric layer 16 is partially covered with a conductive layer 18 which corresponds to the anode of the micro fuel cell. The anode 18 is composed, for example, of a metallic conductor such as gold Au. The dielectric layer and the anode comprise an array of holes that allow the diffusion of the gaseous fuels. The anode 18 is covered with a layer obtained from the catalytic particulate solution that makes it possible to catalyze the reaction at the anode.

The layer 20 obtained from the catalytic particulate solution is in contact with a film of proton-conducting material 22, for example a layer of perfluorosulfonic acid/PTFE copolymer in its acid form (IUPAC name: 1,1,2,2-tetrafluoroethene; 1,1,2,2-tetrafluoro-2-[1,1,1,2,3,3-hexafluoro-3-(1,2,2-trifluoroethenoxy)propan-2-yl]oxyethanesulfonic acid), available commercially under the name NAFION®.

The film of proton-conducting material 22 constitutes the electrolyte of the micro fuel cell 10.

Similarly, positioned on the film of proton-conducting material 22 is a new layer 25 obtained from the catalytic particulate solution covered with a conductive layer 24 which corresponds to the cathode of the micro fuel cell. The cathode 24 may have a hole-array structure in order to enable the diffusion of the oxidizing agent, generally in the form of oxygen from the air. The cathode 24 may be composed, for example, of a metallic conductor such as gold Au.

The layer 20 obtained from the catalytic particulate solution in contact with the anode 18 makes it possible to catalyze the oxidation reaction of the fuel, for example in the form of dihydrogen. The layer 25 obtained from the catalytic particulate solution in contact with the cathode 24 makes it possible to catalyze the reduction reaction of the oxidizing agent, for example in the form of oxygen from the air.

In one embodiment, the same layer obtained from the catalytic particulate solution may be used to catalyze the oxidation reaction and reduction reaction.

One example of a catalytic particulate solution according to the invention comprises:
a suspension of catalytic nanoparticles in the form of carbon nanoparticles in a solvent,
a polymerizable oligomer,
an initiator for the polymerization reaction of the oligomer,
and also binders and dispersants.

The catalytic nanoparticles represent more than 1 and less than 30%, preferably less than 10%, as a percentage by weight, of the catalytic particulate solution. They may be in the form of carbon powder or else of carbon nanotubes comprising a catalytic metal. The carbon nanoparticles have a characteristic dimension of the order of 50 nm.

The catalytic metal may be chosen from elements from group 6 which comprise chromium (Cr), molybdenum (Mo) and tungsten (W), elements from group 7, which includes manganese (Mn), technetium (Tc) and rhenium (Re), elements from group 8, which includes iron (Fe), ruthenium (Ru) and osmium (Os), elements from group 9, which includes cobalt (Co), rhodium (Rh) and iridium (Ir), elements from group 10, which includes nickel (Ni), palladium (Pd) and platinum (Pt), elements from group 11, which includes copper (Cu), silver (Ag), gold (Au) or else zinc (Zn), tin (Sn) or aluminum (Al) or a combination of these elements.

For example, the metallic catalyst comprises Ru, or Pd, or Os, or Ir, or Pt or a combination of these elements. Furthermore for example, the metallic catalyst consists of Pt.

The suspension of catalytic particles may be obtained in an organic or aqueous solvent. For example, the solvent used is a solvent for which the evaporation temperature at atmospheric pressure is substantially less than or equal to 100° C. Water is one solvent which can be used. The solvent represents between 70 and 90%, as a percentage by weight, of the catalytic particulate solution.

The binders and dispersants make it possible to adjust the physical properties of the particulate solution. For example, they ensure the homogeneity of the solution in order to prevent problems of flocculation or sedimentation of the nanoparticles in the solution. These binders and dispersants may also make it possible to improve the deposition of the particulate solution, for example by spraying, and its hold on the substrate after conversion.

The binders and dispersants represent between 5 and 20%, as percentage by weight, of the catalytic particulate solution.

The binders and dispersants may comprise one or more of the following compounds: acrylates, epoxides, polyester and acrylics.

The polymerizable oligomer and the initiator are chosen so that the initiator can initiate the polymerization reaction of the oligomer.

The oligomer is chosen so as to enable, once its polymerization has started, a very rapid increase in the viscosity of the particulate solution. For example, the viscosity of the particulate solution changes from between around 1 mPa·s (milliPascal second equivalent to 1 Cp) and 20 mPa·s, before the polymerization reaction of the oligomer, to between around 100 mPa·s and 200 mPa·s at the time it is deposited on the hole-array of the micro fuel cell.

The oligomer may, for example, be polymerizable according to a chain reaction. Indeed, the chain polymerization reactions make it possible to obtain polymers having an average degree of polymerization, for example n of between 10³ and 10⁶, in a short time, for example between 1 s and 1 min.

During the polymerization reaction, an active center adds one molecule of oligomer in a very short time, of the order of 10⁻⁵ s, and gives rise to a new active center.

The oligomers may be, for example, DPGDA (dipropylene glycol diacrylate) or HDDA (hexanediol diacrylate).

The initiator is a compound comprising at least one activating chemical functional group that enables, when this is activated, the initiation of the polymerization reaction of the oligomer. The initiator may, for example, comprise a functional group which decomposes into free radicals, or becomes positively or negatively charged under the control of an external factor.

The external factor may, for example, be the temperature of the medium. In this case, above a given temperature the activating chemical functional group is activated, for example it decomposes into free radicals which will be able to initiate the polymerization reaction of the oligomer.

The external factor may, for example, be electromagnetic radiation, for example infrared radiation, light, UV rays, X rays, gamma rays or else particle radiation.

Among the initiators which may be used, mention may be made of photoinitiators, they absorb UV radiation and decompose into free radicals with react with the oligomers in order to form a polymer. The photoinitiators may be, for example, alpha-hydroxy ketones, benzyl dimethyl ketal, and bis(acyl)phosphine oxide.

In one embodiment, the oligomer may comprise an activating chemical functional group that enables the initiation of the polymerization reaction. The oligomer may, for example, comprise a photosensitive functional group that decomposes into free radicals under UV radiation at a given wavelength.

A process for depositing the catalytic particulate solution as described above may comprise a step of depositing the particulate solution on the anode or the cathode of a micro fuel cell, during which the polymerization of the oligomer is initiated, for example by means of UV light.

The deposition may be carried out by means of deposition techniques known to a person skilled in the art, in particular spraying.

In one embodiment of the process according to the invention, the initiator is added to the catalytic particulate solution just before the deposition.

Advantageously, this makes it possible to prevent the polymerization reaction of the oligomer from initiating and increasing the viscosity of the particulate solution before it is deposited.

In order to ensure an even more rapid increase in the viscosity of the particulate solution at the time of its deposition, the process according to the invention may comprise a step of heating the substrate, for example Si, on which the electrodes of the micro fuel cell are positioned, to a temperature between 30° C. and 100° C., or else between 50° C. and 100° C.

Advantageously, the heating of the substrate makes it possible to increase the polymerization rate of the oligomer and therefore to more rapidly increase the viscosity. Furthermore, the heating of the substrate may enable an evaporation of the solvent from the catalytic particulate solution also increasing the viscosity of said particulate solution.

FIG. 2 illustrates a step of depositing via spraying, the catalytic particulate solution onto an electrode 18 of a micro fuel cell.

In this embodiment, the initiator is added to the catalytic particulate solution beforehand and the assembly is placed in a spray nozzle 28.

The catalytic particulate solution is then sprayed in the form of fine droplets 20 onto the surface of the electrode 18.

The fine droplets of particulate solution 28 are placed under UV radiation 30 which makes it possible to initiate the polymerization reaction of the oligomer contained in the particulate solution and thus to increase the viscosity of the catalytic particulate solution.

Typically, the catalytic particulate solution has a viscosity between 1 mPa·s and 20 mPa·s when it is in the spray nozzle 28. The addition of the polymerization oligomer into the particulate solution according to the invention makes it possible to increase the viscosity of the particulate solution up to a value between 100 mPa·s and 200 mPa·s when it is deposited on the electrodes 18.

The invention is not limited to the embodiments or examples described and should be interpreted nonlimitingly, encompassing any equivalent example or embodiment.

1. A catalytic particulate solution adapted for use in a micro fuel cell comprising a suspension of catalytic nanoparticles in a solvent and a polymerizable oligomer.

2. The particulate solution as claimed in claim 1, wherein the oligomer is polymerizable according to a chain reaction.

3. The particulate solution as claimed in claim 1, wherein the oligomer is selectively activatable.

4. The particulate solution as claimed in claim 1, wherein the solution comprises an initiator for the polymerization reaction of the oligomer.

5. The particulate solution as claimed in claim 1, wherein the solution comprises a proton-conducting polymer.

6. The particulate solution as claimed in claim 1, wherein the catalytic nanoparticles are in the form of carbon nanoparticles bonded to a catalyst.

7. The particulate solution as claimed in claim 1, wherein the catalytic nanoparticles comprise at least one metal catalyst comprising an element selected from groups 6 to 11 of the Periodic Table.

8. The particulate solution as claimed in claim 1, wherein the solution comprises a catalyst for the polymerization reaction of the oligomer.

9. The particulate solution as claimed in claim 1, wherein the solvent is aqueous.

10. The particulate solution as claimed in claim 1, wherein the solution comprises a proton-conducting polymer, and wherein the proton-conducting polymer and the oligomer are chosen so as not to react together during the polymerization reaction.

11. A process, comprising:
forming a catalytic particulate solution comprising a suspension of catalytic nanoparticles in a solvent and a polymerizable oligomer;
depositing the particulate solution onto a substrate; and
initiating polymerization of the oligomer.

12. The process as claimed in claim 11, further including before depositing, adding a photosensitive initiator for the polymerization reaction of the oligomer to the catalytic particulate solution.

13. The process as claimed in claim 11, further comprising before depositing, heating the substrate is heated to a temperature between 30° C. and 100° C.

14. A fuel cell, comprising:
electrodes;
a catalytic layer placed in contact with the electrodes;
wherein said catalytic layer originates from a catalytic particulate solution comprising a suspension of catalytic nanoparticles in a solvent and a polymerizable oligomer.

15. The fuel cell of claim 14, wherein the fuel cell comprises a power source for an electronic component.

16. The particulate solution as claimed in claim 3, wherein the selectively activatable oligomer is photoactivatable.

17. The particulate solution as claimed in claim 6, wherein the carbon nanoparticles of the catalytic nanoparticles are in the form of carbon nanotubes.

18. The process as claimed in claim 11, wherein initiating polymerization of the oligomer comprises exposing to UV light.
